(19) United States
(12) Patent Application Publication
(10) Pub. No.: US 2017/0329640 A1
(43) Pub. Date: Nov. 16, 2017

(54) SYSTEMS AND METHODS FOR DESIGNATING STORAGE PROCESSING UNITS AS COMMUNICATION HUBS AND ALLOCATING PROCESSING TASKS IN A STORAGE PROCESSOR ARRAY

(71) Applicant: HGST Netherlands B.V., Amsterdam (NL)

(72) Inventors: Zvonimir Z. Bandic, San Jose, CA (US); Arup De, Milpitas, CA (US); Kiran Kumar Gunnam, Milpitas, CA (US)

(21) Appl. No.: 15/151,421

(22) Filed: May 10, 2016

(51) Int. Cl. G06F 9/50; G06F 3/06

(52) U.S. Cl. CPC G06F 9/5016; G06F 3/0685; G06F 3/0604; G06F 3/0631

(57) ABSTRACT

Systems and methods for designating a storage processing unit as a communication hub(s) in a SSD storage system are provided. The storage system can include a host, storage processing units (SPUs), and a host interface to enable communications between host and SPUs. One such method involves receiving a processing task including multiple threads to be performed, determining a baseline configuration for scheduling execution of threads on SPUs and a baseline cost function, marking one SPU as a communication hub, rescheduling, if a thread scheduled for execution on any of the other SPUs is decomposable to multiple sub-threads, a first sub-thread for execution on marked SPU, evaluating a second cost function for performing the processing task, including first sub-thread rescheduled on marked SPU, based on same factors as the baseline cost function, and unmarking, if baseline cost function is less than second cost function, the marked SPU.

### FIELD

Aspects of the disclosure relate generally to solid state drives (SSDs), and more specifically, to systems and methods for designating storage processing units as communication hub(s) and allocating processing tasks in a SSD storage processor array.

### BACKGROUND

In a variety of consumer electronics, solid state drives (SSDs) incorporating non-volatile memories (NVMs) are frequently replacing or supplementing conventional rotating hard disk drives for mass storage. These SSDs are often grouped together in storage arrays. In a traditional compute and storage model for SSD storage arrays, the host handles the computation tasks and storage arrays handle the storage tasks. It may be possible to offload input/output and data intensive application tasks to the storage array or to a cluster of SSDs. In several applications, there is still a significant need for communication between the storage processing units (SPUs) that make up the storage array. This communication can be achieved either through host or peer to peer communication using the host interface bus, which is often implemented using a Peripheral Component Interconnect Express (PCIe) bus. However either of these approaches quickly leads to saturation of the host and/or the host interface bus as undesirably low bus speeds become a bottleneck for such communications.

### SUMMARY

In one aspect, this disclosure relates to a method for designating a storage processing unit as a communication hub in a storage system including a host, a plurality of storage processing units (SPUs) each including a non-volatile memory (NVM) and a processor, and a host interface configured to enable communications between the host and each of the plurality of SPUs, the method including (1) receiving, at the host, a processing task to be performed, the processing task including a plurality of threads, (2) determining, at the host, a baseline scheduling configuration for scheduling execution of the plurality of threads on the plurality of SPUs and a corresponding baseline cost function for performing the processing task using the baseline scheduling configuration based on at least one performance factor including at least one of a computation time of the plurality of SPUs, a power dissipation of the plurality of SPUs, or a traffic on the host interface, (3) marking, at the host, one of the plurality of SPUs as a communication hub configured to send data to, and receive data from, the other SPUs, (4) rescheduling, if a thread scheduled for execution on any of the other SPUs is decomposable to multiple sub-threads, a first sub-thread of the decomposable threads for execution on the marked SPU, (5) evaluating a second cost function for performing the processing task, including the first sub-thread rescheduled on the marked SPU, based on the at least one performance factor, and (6) unmarking, if the baseline cost function is less than the second cost function, the marked SPU.

In another aspect, this disclosure relates to a system for designating a storage processing unit as a communication hub in a storage system including, the system including a host, a plurality of storage processing units (SPUs) each including a non-volatile memory (NVM) and a processor, a host interface configured to enable communications between the host and each of the plurality of SPUs, and wherein the host is configured to (1) receive a processing task to be performed, the processing task including a plurality of threads, (2) determine a baseline scheduling configuration for scheduling execution of the plurality of threads on the plurality of SPUs and a corresponding baseline cost function for performing the processing task using the baseline scheduling configuration based on at least one performance factor including at least one of a computation time of the plurality of SPUs, a power dissipation of the plurality of SPUs, or a traffic on the host interface, (3) mark one of the plurality of SPUs as a communication hub configured to send data to, and receive data from, the other SPUs, (4) reschedule, if a thread scheduled for execution on any of the plurality of SPUs other than the marked SPU is decomposable to multiple sub-threads, a first sub-thread of the decomposable threads for execution on the marked SPU, (5) evaluate a second cost function for performing the processing task, including the first sub-thread rescheduled on the marked SPU, based on the at least one performance factor, and (6) unmark, if the baseline cost function is less than the second cost function, the marked SPU.

### BRIEF DESCRIPTION OF THE DRAWINGS

FIG. 1 is a block diagram of a storage system including a solid state device (SSD) array with a host and a host interface coupled to multiple storage processing units (SPUs) where the host is configured to designate one or more SPUs to act as a communication hub(s) based on a particular processing task in accordance with one embodiment of the disclosure.

FIG. 2 is a block diagram of a storage processing unit (SPU) including a non-volatile memory storage unit and one or more computing accelerators in accordance with one embodiment of the disclosure.

FIG. 3 is a flow chart of a host process for designating/marking one or more storage processing units to act as a communication hub(s) based on a particular processing task in a solid state device (SSD) storage processor array in accordance with one embodiment of the disclosure.

FIG. 4 is a table illustrating processing sub-tasks performed by various SPUs over time in a baseline configuration where no SPUs are designated/marked as a communication hub in accordance with one embodiment of the disclosure.

FIG. 5 is a table illustrating processing sub-tasks performed by various SPUs over time in a modified configuration where two SPUs are designated/marked as communication hubs in accordance with one embodiment of the disclosure.

### DETAILED DESCRIPTION

Referring now to the drawings, systems and methods for designating one or more storage processing units to act as a communication hub(s) in a SSD storage system based on a particular processing task are illustrated. In one embodiment, the storage system includes a host, a plurality of storage processing units (SPUs) each including a non-volatile memory (NVM) and a processor, and a host interface configured to enable communications between the host and each of the plurality of SPUs. In one aspect, the method involves (1) receiving, at the host, a processing task to be performed, the processing task including a plurality of threads, (2) determining, at the host, a baseline scheduling configuration for scheduling execution of the plurality of threads on the plurality of SPUs and a corresponding baseline cost function for performing the processing task using the baseline scheduling configuration based on at least one performance factor including at least one of a computation time of the plurality of SPUs, a power dissipation of the plurality of SPUs, or a traffic on the host interface. The method can further involve (3) marking, at the host, one of the plurality of SPUs as a communication hub configured to send data to, and receive data from, the other SPUs, (4) rescheduling, if a thread scheduled for execution on any of the other SPUs is decomposable to multiple sub-threads, a first sub-thread of the decomposable thread for execution on the marked SPU, (5) evaluating a second cost function for performing the processing task, including the first sub-thread rescheduled on the marked SPU, based on the at least one performance factor, and (6) unmarking, if the baseline cost function is less than the second cost function, the marked SPU.

In one aspect, the method can also involve (7) stopping if a preselected end condition is achieved, but otherwise repeating actions (3) to (6) for the remaining SPUs of the plurality of SPUs.

In several aspects, the method may designate/mark/select the SPU(s) to act as a communication hub to optimize system efficiency by, for example, minimizing the computation time of the SPUs, the power dissipation of the SPUs, and the traffic on the host interface. In several aspects, the method marks the SPU(s) based on the particular processing task (e.g., application) to be performed. In one aspect, the method effectively analyzes the efficiency of multiple scheduling configurations for various marked SPU(s) and threads of the processing task scheduled on various SPUs to find an optimum scheduling configuration for a given processing task. Thus, the methods can modify thread scheduling, computation restructuring and algorithmic transformation. The methods may reduce the traffic on the host interface (e.g., shared PCIe bus) as well as reduce the overall computation time. This may reduce overall power consumption and increase performance of the storage system.

In several embodiments, the SPU may be considered a non-volatile memory storage unit with computation capabilities. In several aspects, a SPU marked as a communication hub acts as a network node may collect data from other nodes and send data to other nodes.

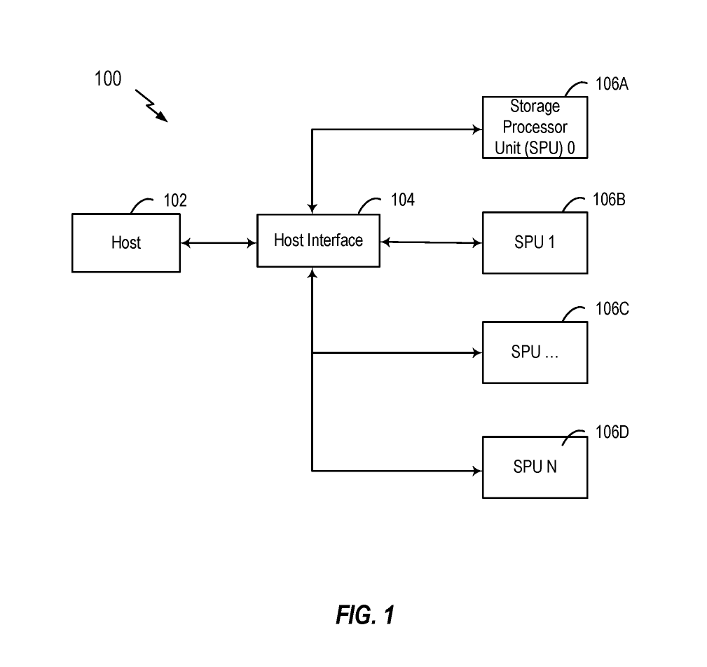

FIG. 1 is a block diagram of a storage system 100 including a solid state device (SSD) array with a host 102 and a host interface 104 coupled to multiple storage processing units (SPUs) (106A-106D) where the host 104 is configured to designate one or more SPUs (106A-106D) to act as a communication hub(s) based on a particular processing task in accordance with one embodiment of the disclosure.

The host 102 is configured to send data to, and receive data from, each of the SPUs (106A-106D) via the host interface 104. The data can be stored at the SPUs (106A-106D). As will be described in greater detail below, the host 102 may also offload preselected processing tasks, or threads of the tasks, to one or more of the SPUs to decrease its workload and/or for other purposes related to efficiency of the system. The host 102 may include a host central processing unit (CPU) or other suitable processing circuitry, a host dynamic random access memory (DRAM), and/or low level software or firmware such as a device driver. In one aspect, the host 102 may include an application programming interface (API) to offload the processing tasks (e.g., computations) to the SPUs. In one aspect, the host 102 is configured to command at least one of the SPUs 106A-106D to perform one or more processing tasks or processing sub-tasks such as threads.

The host interface 104 can be implemented using any number of suitable bus interfaces, including, for example, a Peripheral Component Interconnect Express (PCIe) bus interface, a serial AT attachment (SATA) bus interface, a serial attached small computer system interface (SASCSI or just SAS), or another suitable hard drive bus interface known in the art. As described above, the host interface 104 may become saturated as the host 102 and/or SPUs 106A-106D bog down the bus with a high volume of communication.

The storage processing units 106A-106D may include a non-volatile memory (NVM) storage unit and one or more computing accelerators. In such case, the NVM can be configured to store data while the computing accelerators can be configured to perform various processing tasks (e.g., perform local processing). In several embodiments, the NVM may include flash memory. Flash memory stores information in an array of floating gate transistors, called “cells”, and can be electrically erased and reprogrammed in blocks. In some embodiments, the NVM may include storage class memory such as resistive random access memory (RRAM or ReRAM), phase change memory (PCM), magneto-resistive random access memory (MRAM) such as spin transfer torque (STT) MRAM, three dimensional cross point (3D XPoint) memory, and/or other suitable non-volatile memory. The 3D)(Point memory can be a non-volatile memory technology in which bit storage is based on a change of bulk resistance, in conjunction with a stackable cross-gridded data access array.

In operation, the host 102 can configured to receive a processing task (e.g., application) to be performed where the processing task is composed of multiple threads. The host 102 can also be configured to determine a baseline scheduling configuration for scheduling execution of the threads on the SPUs and a corresponding baseline cost function for performing the processing task using the baseline scheduling configuration based on one or more performance factors. This factor can include a computation time of the SPUs, a power dissipation of the SPUs, a traffic on the host interface, and/or other suitable performance characteristics. The host 102 can be further configured to mark one of the SPUs as a communication hub that is configured to send data to, and receive data from, the other SPUs. The host 102 can be further configured to reschedule, if a thread scheduled for execution on any of the other SPUs (e.g., SPUs other than the marked SPU) is decomposable to multiple sub-threads, a first sub-thread of the decomposable threads for execution on the marked SPU. The host 102 can be further configured to evaluate a second cost function for performing the processing task, including the first sub-thread rescheduled on the marked SPU, based on the one or more performance factors as are used for the baseline cost function, and to unmark, if the baseline cost function is less than the second cost function, the marked SPU. Thus, the host 102 can be configured to effectively determine an optimized configuration of the SPUs, which includes one or more SPUs marked as communication hubs, based on on how efficiently the SPU configuration will be able to perform the processing task which includes, among other things, not facilitating a bottleneck of traffic on the host interface. This determination may often involve an iterative process examining different configurations of marked SPUs and scheduled threads. Additional details about the SPU marking process will be described below.

In the context described above, the host CPU or SPU computing accelerators can refer to any machine or selection of logic that is capable of executing a sequence of instructions and should be taken to include, but not limited to, general purpose microprocessors, special purpose microprocessors, central processing units (CPUs), digital signal processors (DSPs), application specific integrated circuits (ASICs), signal processors, microcontrollers, and other suitable circuitry. Further, it should be appreciated that the term processor, microprocessor, circuitry, controller, and other such terms, refer to any type of logic or circuitry capable of executing logic, commands, instructions, software, firmware, functionality, or other such information.

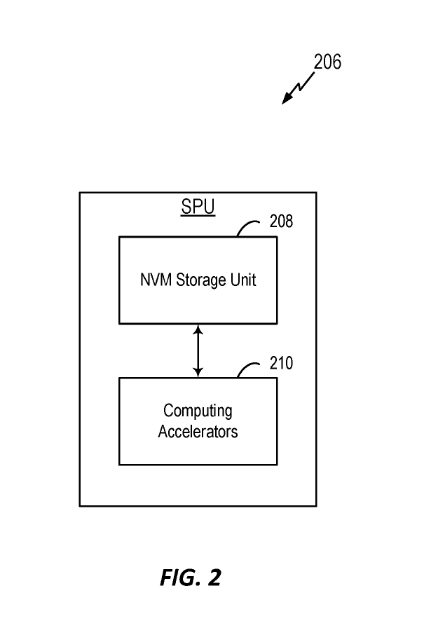

FIG. 2 is a block diagram of a storage processing unit (SPU) 206 including a non-volatile memory storage unit 208 and one or more computing accelerators 210 in accordance with one embodiment of the disclosure. The NVM 208 may include flash memory or other suitable non-volatile memory. Flash memory stores information in an array of floating gate transistors, called “cells”, and can be electrically erased and reprogrammed in blocks. The computing accelerators may include one or more processing circuits configured to perform tasks assigned by a host. Other aspects of NVMs and computing accelerators are not described here but are well known in the art.

In several embodiments, the SPU 206 further includes first communication circuitry (e.g., input/output circuitry such as is configured for PCIe) for communicating on a host interface network such as host interface 104 in FIG. 1. This first communication circuitry can include one or more ports configured for communicating single or multiple bits of information (e.g., communication could be serial or parallel).

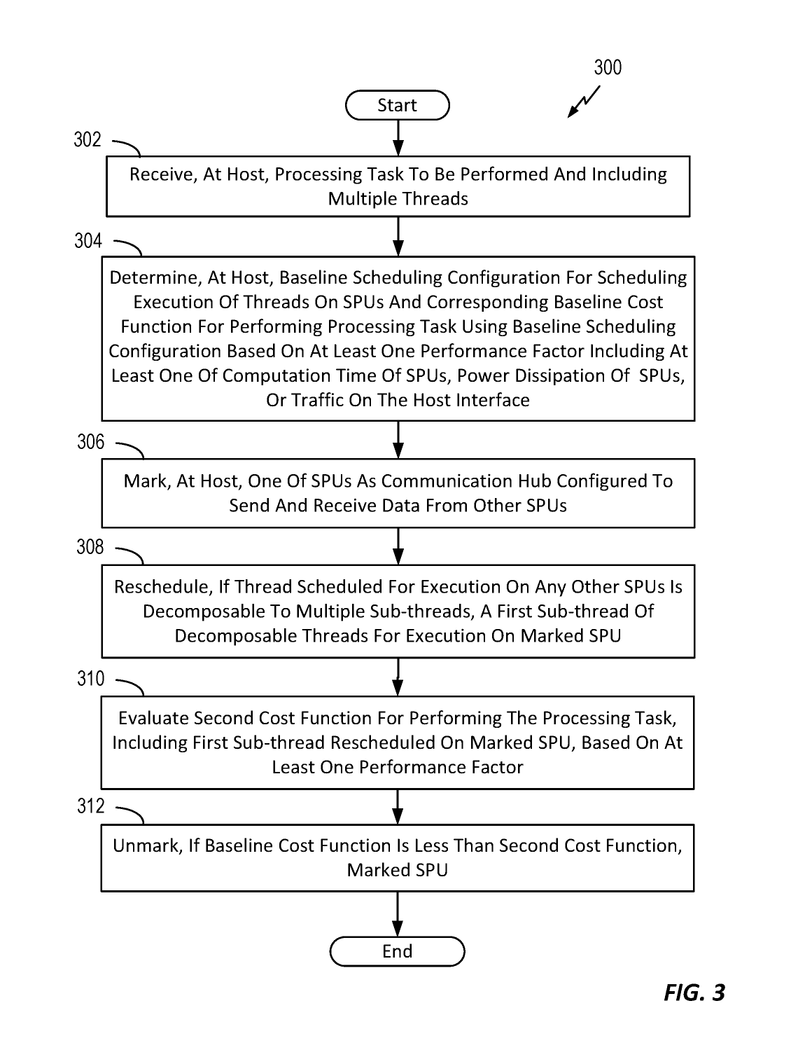

FIG. 3 is a flow chart of a host process 300 for designating/marking one or more storage processing units to act as a communication hub(s) based on a particular processing task in a solid state device (SSD) storage processor array in accordance with one embodiment of the disclosure. In particular embodiments, process 300 can be performed by the host 102 of FIG. 1. In many embodiments, the process 300 is performed by a host in a storage system including a host interface coupled to the host and multiple storage processing units (SPUs) each including a non-volatile memory (NVM) and a processor, where the host interface is configured to enable communications between the host and each of the SPUs.

In block 302, the process receives, at the host, a processing task to be performed, the processing task including a plurality of threads. In one aspect, the processing task can also be referred to as an application or a workload. One example of the processing task is a mathematical computation involving one or more Fourier transforms or matrix multiplication. In one aspect, the process may work particularly well for workloads that have thread level parallelism such that each thread can be scheduled to a SPU.

In block 304, the process determines, at the host, a baseline scheduling configuration for scheduling execution of the plurality of threads on the plurality of SPUs and a corresponding baseline cost function for performing the processing task using the baseline scheduling configuration based on at least one performance factor including at least one of a computation time of the plurality of SPUs, a power dissipation of the plurality of SPUs, or a traffic on the host interface. In other embodiments, the baseline cost function can be based on additional factors or other factors related to efficiency of the storage system. One such factor could involve choosing an SPU that has less latency on the host interface than other SPUs. Another factor, for example, could involve restructuring computations (e.g., changing the order or grouping of computations without necessarily changing the final output). Yet another factor could involve algorithmic transformations which generally do not alter the input-output behavior of the system, but do change the internal structure of the algorithm to increase the level of concurrency. In some embodiments, the at least one performance factor includes two or more of the factors enumerated above. In one such embodiment, the at least one performance factor includes all three of the factors enumerated above and/or any of the additional factors. In one aspect, the process determines the baseline scheduling configuration in an iterative manner. For example, the process may (1) simulate multiple scheduling configurations of all of the plurality of threads on the plurality of SPUs, (2) determine, for each of the multiple scheduling configurations, a cost function with factors including one or more of the computation time of the plurality of SPUs, the power dissipation of the plurality of SPUs, or the traffic on the host interface, and (3) determine which of the multiple scheduling configurations has a lowest value for the cost function and store it as the baseline scheduling configuration. In several embodiments, the process determines the baseline scheduling configuration in block 304 without marking any SPUs as communication hubs.

In block 306, the process marks, at the host, one of the plurality of SPUs as a communication hub configured to send to, and receive data from, the other SPUs. In one aspect, the marked SPU is configured to autonomously send and receive data from the other SPUs, and the unmarked SPUs are not configured to autonomously send and receive data from the other SPUs. In one aspect, the process may mark two or more SPUs at a time. In one aspect, the SPUs may all have equal resources (memory such as dynamic random access memory or DRAM and/or processing power). In other aspects, the SPUs may have unequal resources. In one such case, the marking or selection of SPUs may be weighted towards those SPUs with greater resources. In one aspect, the marking may include storing information at the host that a particular SPU is marked and storing similar information at the marked SPU. In some aspects, marking includes sending a message from the host to all of the SPUs notifying them of the marked SPUs.

In block 308, the process reschedules, if a thread scheduled for execution on any of the other SPUs (e.g., the SPUs other than the marked SPU) is decomposable to multiple sub-threads, a first sub-thread of the decomposable threads for execution on the marked SPU. In such case, the host can notify the SPU with the first sub-thread not to perform the thread and command the marked SPU to perform the first sub-thread. In one aspect, the process also schedules data transfer(s) to the marked SPU of any data needed to perform the first sub-thread.

In block 310, the process evaluates a second cost function for performing the processing task, including the first sub-thread rescheduled on the marked SPU, based on the at least one performance factor (e.g., including at least one of the computation time of the plurality of SPUs, the power dissipation of the plurality of SPUs, or the traffic on the host interface). Having marked one or more SPUs, the process can effectively re-evaluate the cost function and see whether the second cost function is less than the baseline cost function.

In block 312, the process unmarks, if the baseline cost function is less than the second cost function, the marked SPU. Thus, the process effectively unmarks the marked SPU if the corresponding SPU configuration is not more efficient than the baseline configuration where no SPUs were marked.

In one embodiment, the process also stops if a preselected end condition is achieved, but otherwise repeats the actions of blocks 306 through 312 for the remaining SPUs of the plurality of SPUs. In one aspect, the preselected end condition is one or more of (1) the computation time is less than a preselected computation time target (e.g., execute processing task in less than 10 microseconds), (2) the power dissipation is less than a preselected power dissipation target, or (3) the traffic on the host interface is less than a preselected traffic target. In another aspect, the process also stops if the process determines that the cost function cannot be further improved over multiple iterations. If the process is repeating the actions of blocks 306 through 312, then in block 312, the process can unmark, if the previous iteration cost function is less than the current iteration cost function (e.g., the second cost function of the current iteration), the marked SPU of the current iteration.

In several aspects, the process effectively determines the most efficient scheduling configuration with marked SPUs for a given processing task/workload/application. This most efficient scheduling configuration can include both the most efficient thread scheduling on the SPUs and the most efficient markings of SPUs as communication hubs.

In one aspect, the process can further include additional actions such as those found in various genetic and/or simulated annealing algorithms.

In several embodiments, the process determines the power dissipation of all of the SPUs to consider in the baseline and second cost functions. In another embodiment, the process determines the power dissipation of all of the SPUs and the host. In some embodiments, the process can determine the power dissipation from direct measurement resources available on the hardware (e.g., circuit board(s)) of the storage system. In other embodiments, the process can determine the power dissipation using computations that estimate the power dissipation.

In one aspect, the process can perform the sequence of actions in a different order. In another aspect, the process can skip one or more of the actions. In other aspects, one or more of the actions are performed simultaneously. In some aspects, additional actions can be performed.

In one aspect, the process effectively accounts for the communication overhead when scheduling threads and computations to storage processor array. Thus, the process can modify thread scheduling, computation restructuring and algorithmic transformation. The process may reduce the traffic on the host interface (e.g., shared PCIe bus) as well as reduce the overall computation time. This may reduce overall power consumption and increase performance of the storage system.

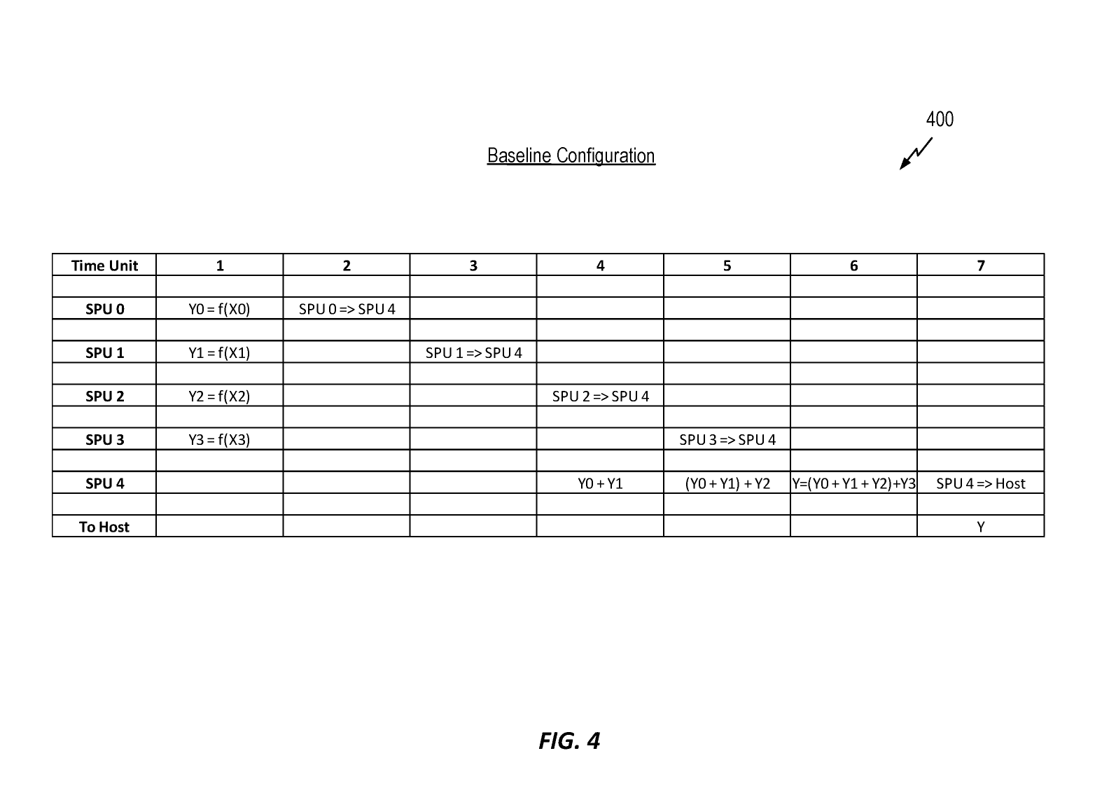

FIG. 4 is a table 400 illustrating processing sub-tasks performed by various SPUs (e.g., SPU 0 to SPU 4) over time (e.g., time unit 1 to 7) in a baseline configuration where no SPUs are designated/marked as a communication hub in accordance with one embodiment of the disclosure. In the baseline configuration, assume that SPU 0, SPU 1, SPU 2, and SPU 3 already have vectors X0, X1, X2, and X3 stored locally. It is desired to compute Y0=f(X0) on SPU 0, Y1=f(X1) on SPU 1, Y2=f(X2) on SPU 2, Y3=f(X3) on SPU 3, and Y=Y0+Y1+Y2+Y3 on SPU 4, and then send the result back to the host on the host interface (e.g., PCIe). Thus, there are a total of 4 peer-to-peer links or transfers (SPU 0/1/2/3=>SPU 4) and one SPU to PCIe link/transfer (SPU 4 to host). For the sake of simplicity it can be assumed that the time unit for each computation and data transfer are the same. In general however, these times are not the same. As discussed above, there are a total of 5 transfers each involving the host interface (e.g., PCIe bus). There are also 7 computations (e.g., 4 in cycle 1 and 1 in each of cycles 4, 5, and 6). The processing task is completed in 7 cycles. In one aspect, the baseline configuration can be comparable to the baseline scheduling configuration in block 304 of FIG. 3 where no SPUs have been marked as communication hubs at that stage.

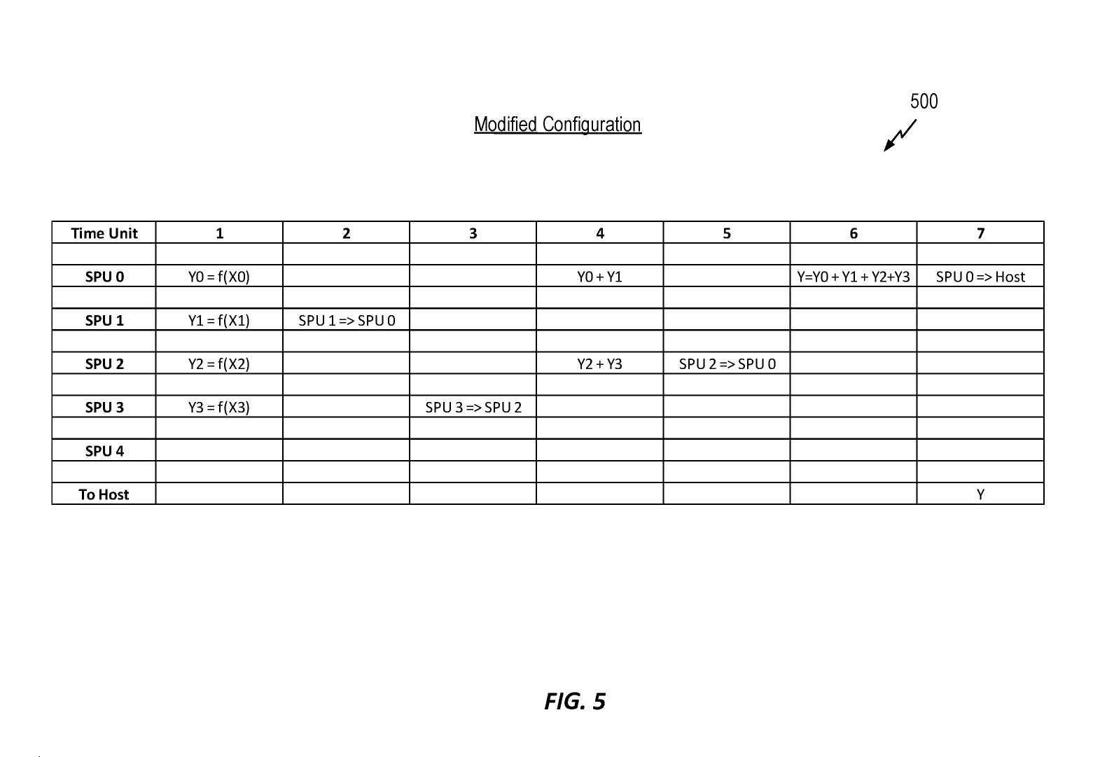

FIG. 5 is a table 500 illustrating processing sub-tasks performed by various SPUs over time in a modified configuration where two SPUs (SPU 0, SPU 2) are designated/marked as communication hubs in accordance with one embodiment of the disclosure. This modified configuration is the same as the baseline configuration of FIG. 4 except that the two SPUs have been marked as communication hubs. As a result some of the computations and transfers are rescheduled.

In the modified configuration of FIG. 5, it is again assumed that SPU 0, SPU 1, SPU 2, and SPU 3 already have vectors X0, X1, X2, and X3 stored locally. It is desired to compute Y0=f(X0) on SPU 0, Y1=f(X1) on SPU 1, send Y1 to SPU 0, and compute Y0+Y1 on SPU 0. It is also desired to compute Y2=f(X2) on SPU 2, Y3=f(X3) on SPU 3, send Y3 to SPU 2, and compute Y2+Y3 on SPU 2. Then send Y2+Y3 to SPU 0, compute Y=Y0+Y1+Y2+Y3 on SPU 0, and then send the result back to the host on the host interface (e.g., PCIe).

In the modified configuration, there are a total of 4 transfers each involving the host interface (e.g., PCIe bus). There are also 7 computations (e.g., 4 in cycle 1, 2 in cycle 4, and 1 in cycle 6). The processing task is completed in 7 cycles. Thus, as compared with the baseline configuration, there is slightly less transfers/traffic on the host interface (e.g., PCIe bus). As such, if the process of FIG. 3 were being applied to the modified configuration in block 312, the baseline cost function would be greater than the second cost function, and the marking of the two SPUs would be maintained (e.g., they would not be unmarked).

While the above description contains many specific embodiments of the invention, these should not be construed as limitations on the scope of the invention, but rather as examples of specific embodiments thereof. Accordingly, the scope of the invention should be determined not by the embodiments illustrated, but by the appended claims and their equivalents.

The various features and processes described above may be used independently of one another, or may be combined in various ways. All possible combinations and sub-combinations are intended to fall within the scope of this disclosure. In addition, certain method, event, state or process blocks may be omitted in some implementations. The methods and processes described herein are also not limited to any particular sequence, and the blocks or states relating thereto can be performed in other sequences that are appropriate. For example, described tasks or events may be performed in an order other than that specifically disclosed, or multiple may be combined in a single block or state. The example tasks or events may be performed in serial, in parallel, or in some other suitable manner. Tasks or events may be added to or removed from the disclosed example embodiments. The example systems and components described herein may be configured differently than described. For example, elements may be added to, removed from, or rearranged compared to the disclosed example embodiments.

What is claimed is:

1. A method for designating a storage processing unit as a communication hub in a storage system comprising a host, a plurality of storage processing units (SPUs) each comprising a non-volatile memory (NVM) and a processor, and a host interface configured to enable communications between the host and each of the plurality of SPUs, the method comprising:
(1) receiving, at the host, a processing task to be performed, the processing task comprising a plurality of threads;
(2) determining, at the host, a baseline scheduling configuration for scheduling execution of the plurality of threads on the plurality of SPUs and a corresponding baseline cost function for performing the processing task using the baseline scheduling configuration based on at least one performance factor including at least one of:
a computation time of the plurality of SPUs,
a power dissipation of the plurality of SPUs, or
a traffic on the host interface;
(3) marking, at the host, one of the plurality of SPUs as a communication hub configured to send data to, and receive data from, the other SPUs;
(4) rescheduling, if a thread scheduled for execution on any of the other SPUs is decomposable to multiple sub-threads, a first sub-thread of the decomposable threads for execution on the marked SPU;
(5) evaluating a second cost function for performing the processing task, including the first sub-thread rescheduled on the marked SPU, based on the at least one performance factor; and
(6) unmarking, if the baseline cost function is less than the second cost function, the marked SPU.

2. The method of claim 1, further comprising:
stopping if a preselected end condition is achieved, but otherwise repeating (3) to (6) for the remaining SPUs of the plurality of SPUs.

3. The method of claim 2, wherein the preselected end condition is at least one of the computation time is less than a preselected computation time target, the power dissipation is less than a preselected power dissipation target, or the traffic on the host interface is less than a preselected traffic target.

4. The method of claim 2, wherein if repeating (3) to (6) for the remaining SPUs of the plurality of SPUs, the unmarking, if the baseline cost function is less than the second cost function, the marked SPU comprises:
unmarking, if the second cost function of the previous iteration is less than the second cost function of the current iteration, the marked SPU of the current iteration.

5. The method of claim 1, wherein the determining, at the host, the baseline scheduling configuration for scheduling execution of the plurality of threads on the plurality of SPUs and the corresponding baseline cost function comprises:
simulating multiple scheduling configurations of all of the plurality of threads on the plurality of SPUs;
determining, for each of the multiple scheduling configurations, a cost function with the at least one performance factor; and
determining which of the multiple scheduling configurations has a lowest value for the cost function and storing the scheduling configuration with the lowest value for the cost function as the baseline scheduling configuration.

6. The method of claim 1:
wherein the marked SPU is configured to autonomously send data to, and receive data from, the other SPUs; and
wherein the unmarked SPUs are not configured to autonomously send data to, and receive data from, the other SPUs.

7. The method of claim 1, further comprising scheduling data transfer(s) to the marked SPU of any data needed to perform the first sub-thread.

8. The method of claim 1, wherein the marking one of the plurality of SPUs as a communication hub comprises marking two of the plurality of SPUs as communication hubs.

9. The method of claim 1, wherein the at least one performance factor comprises at least two of:
the computation time of the plurality of SPUs,
the power dissipation of the plurality of SPUs, or
the traffic on the host interface.

10. The method of claim 1, wherein the at least one performance factor comprises:
the computation time of the plurality of SPUs,
the power dissipation of the plurality of SPUs, and
the traffic on the host interface.

11. A system for designating a storage processing unit as a communication hub in a storage system comprising, the system comprising:
a host;
a plurality of storage processing units (SPUs) each comprising a non-volatile memory (NVM) and a processor;
a host interface configured to enable communications between the host and each of the plurality of SPUs; and
wherein the host is configured to:
(1) receive a processing task to be performed, the processing task comprising a plurality of threads;
(2) determine a baseline scheduling configuration for scheduling execution of the plurality of threads on the plurality of SPUs and a corresponding baseline cost function for performing the processing task using the baseline scheduling configuration based on at least one performance factors including at least one of:
a computation time of the plurality of SPUs,
a power dissipation of the plurality of SPUs, or
a traffic on the host interface;
(3) mark one of the plurality of SPUs as a communication hub configured to send data to, and receive data from, the other SPUs;
(4) reschedule, if a thread scheduled for execution on any of the plurality of SPUs other than the marked SPU is decomposable to multiple sub-threads, a first sub-thread of the decomposable threads for execution on the marked SPU;
(5) evaluate a second cost function for performing the processing task, including the first sub-thread rescheduled on the marked SPU, based on the at least one performance factor; and
(6) unmark, if the baseline cost function is less than the second cost function, the marked SPU.

12. The system of claim 11, wherein the host is further configured to stop if a preselected end condition is achieved, but otherwise repeat (3) to (6) for the remaining SPUs of the plurality of SPUs.

13. The system of claim 12, wherein the preselected end condition is at least one of the computation time is less than a preselected computation time target, the power dissipation is less than a preselected power dissipation target, or the traffic on the host interface is less than a preselected traffic target.

14. The system of claim 12, wherein the host is further configured to, if repeating (3) to (6) for the remaining SPUs of the plurality of SPUs:
unmark, if the second cost function of the previous iteration is less than the second cost function of the current iteration, the marked SPU of the current iteration.

15. The system of claim 11, wherein the host is further configured to:
simulate multiple scheduling configurations of all of the plurality of threads on the plurality of SPUs;
determine, for each of the multiple scheduling configurations, a cost function with the at least one performance factor; and
determine which of the multiple scheduling configurations has a lowest value for the cost function and store it as the baseline scheduling configuration.

16. The system of claim 11:
wherein the marked SPU is configured to autonomously send data to, and receive data from, the other SPUs; and
wherein the unmarked SPUs are not configured to autonomously send data to, and receive data from, the other SPUs.

17. The system of claim 11, wherein the host is further configured to schedule data transfer(s) to the marked SPU of any data needed to perform the first sub-thread.

18. The system of claim 11, wherein the host is further configured to mark two of the plurality of SPUs as communication hubs.

19. The system of claim 11, wherein the at least one performance factor comprises at least two of:
the computation time of the plurality of SPUs,
the power dissipation of the plurality of SPUs, or
the traffic on the host interface.

20. The system of claim 11, wherein the at least one performance factor comprises:
the computation time of the plurality of SPUs,
the power dissipation of the plurality of SPUs, and
the traffic on the host interface.
